(19) United States
(12) Patent Application Publication
(10) Pub. No.: US 2009/0091450 A1
(43) Pub. Date: Apr. 9, 2009

(54) DISTRIBUTED SAFETY APPARATUS

(75) Inventor: Pericles Deavila, North Salt Lake, UT (US)

Correspondence Address: Workman Nydegger;1000 Eagle Gate Tower, 60 East South Temple, Salt Lake City, UT, 84111, US

(73) Assignee: SECTOR 10 HOLDINGS, INC., North Salt Lake, UT (US)

(21) Appl. No.: 11/868,908

(22) Filed: Oct. 8, 2007

(51) Int. Cl. H04B 7/00

(52) U.S. Cl. 340/572.1

(57) ABSTRACT

The present invention provides systems and methods for a distributed safety apparatus which provides location tracking for assets. Assets are associated with asset tags which transmit data to receiver/transmitter units and which are tracked by a processing center. Communications for location tracking as well as wireless communications are provided through vertical shafts of multi-story buildings. Locations of assets may be depicted in two or three-dimensional models of the surroundings of the tracked assets. Devices used within the tracking systems may incorporate other emergency or event response materials.

### CROSS-REFERENCE TO RELATED APPLICATIONS

n/a

### BACKGROUND

The knowledge of the location of people and of tangible assets can be a very important and useful tool. In an emergency, for instance, it can be useful to know where all the people who work in a particular building are—are any trapped inside or have they all successfully been evacuated. In situations other than emergencies, it may still be very useful to have the knowledge of the location of people. For instance, a business may want to know who is present at work at a given time, who is within a sensitive or secure area at a particular time. If there is a certain restricted area, it may be useful to know who has entered the area over a given past period of time.

It may also be useful to have knowledge of the location of physical or tangible assets. Both the present instantaneous location and a track of movement over a past period may be useful. If a laptop or other valuable is not to be taken from a building or an area within a building, it may be useful to know if the asset is being moved from its proper location, know where it is presently, or possibly have an alarm issue which alerts to the movement of the asset.

It may often be problematic in multi-story buildings to enable a comprehensive system whereby all the people and tangible assets which are desired to be tracked can, indeed, be tracked. Part of this problem may stem from the typical difficulty in wireless communication from floor to floor in a typical commercial multi-story building. Floors made of steel and concrete do not generally admit favorably to wireless communications typically used within such facilities. Although a typical building may have vertical shafts which might accommodate communications between floors, building and safety codes generally have prevented the typically deployed communications systems from utilizing such shafts for communications.

### BRIEF SUMMARY

Systems which can track people and tangible assets in general and can track people and tangible assets within multi-story buildings can be very useful. Furthermore, it would be very useful for location information to be available in detailed and specific formats, providing detailed information concerning not only the particular location of a person or asset but also information concerning the location, itself, or the environment surrounding the location. Such location and asset tracking information may be useful for testing procedures such as evacuation plans and disaster response scenarios. It would further be useful to have the ability of such a system to communicate floor to floor within multi-story buildings.

Embodiments of the present invention pertain to embodiments which are useful for tracking the location of people and tangible assets. Embodiments are presented which provide for tracking of assets by using asset tags, receiver/transmitter units, and a processing center. Embodiments are presented which facilitate tracking of assets within and throughout multiple floors of multi-story buildings. Embodiments are presented which provide for receiver/transmitter units to be portable and deployable in the field on an ad hoc basis in order to track assets associated with asset tags and provide additional functionality as described herein.

Embodiments are presented which provide for secondary data networks as well as tracking of asset locations. Embodiments are also presented which provide for emergency and event response equipment to be deployed in conjunction with receiver/transmitters units within a tracking system.

This Summary is provided to introduce a brief selection of concepts in a simplified form. Particular embodiments of the present invention are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates typical hardware and devices which may be used within the present invention;

FIG. 2 illustrates a typical processing center as described and employed within the present invention;

FIG. 3 illustrates a unit comprising both communications functionality and emergency supplies as described within the present invention.

FIG. 4 illustrates a flowchart for a method of determining the location of asset tags;

FIG. 5 illustrates a data structure which is useful in embodiments of the present invention; and

FIG. 6 illustrates a typical use and deployment within a multi-story building of an embodiment of the present invention.

### DETAILED DESCRIPTION

The present invention extends to systems, devices, methods, and computer program products for tracking asset tags and locating assets associated with the asset tags within models. The models may be two-dimensional or three-dimensional representations of the surroundings, area, or environment of the location of the asset tags. The embodiments of the present invention may comprise a special purpose or general-purpose computer including various computer hardware and various communications devices, both wired and wireless, as discussed in greater detail below.

The present invention discloses embodiments for tracking asset tags by using transmitting asset tags, receiver/transmitter (RT) units, and a processing center capable of determining the location of an asset from identification data sent by an asset tag and proximity data determined by one or more RT units. The invention discloses a system comprising an asset tag, an RT unit, and a processing center enabled to determine the location of an asset. The invention further discloses an associated method for receiving asset tag information, determining the proximity of an asset tag to a receiver device, and determining the location of an asset tag.

Other embodiments of the present invention comprise an asset tracking system and include additional enterprise networking functionality. Still other embodiments of the present invention include asset tracking devices and modules housed with emergency response units and supplies.

Systems and computer program products are also described in some embodiments which facilitate the creation and modification of layout compositions. A computing system includes a layout module and an output device. The layout module is configured to receive input and to produce a layout composition. Further, the layout module may receive declarative input, user-commands, or both indicating a desired layout. The layout module can interpret the declarative input or the user-commands. The layout module may also produce a layout composition in accordance with the declarative input or the user-commands. The output device is configured to communicate with the layout module and to output the layout composition produced by the layout module.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

However, it should be understood, that upon reaching various computer system components program code means in the form of computer-executable instructions or data structures can be transferred automatically from transmission media to physical storage media. For example, computer-executable instructions or data structures received over a network or data link can be buffered in RAM within a network interface card, and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines and hardware enabling particular functionality that execute on a computing system. The different components, modules, engines, and services described herein may be implemented as objects or processes that execute on a computing system. Systems and methods described herein may be implemented in software, in hardware, or in a combination of both software and hardware. In this description, a “computing entity” or a “processing center” may be any computing system as defined herein, or any module or combination of modules running on a computing system.

Embodiments of the present invention provide for the tracking of asset tags and their associated assets. The present invention provides that asset tags may be tracked in a distributed area, on multiple floors of multi-story buildings, within individual rooms within buildings, and across widely separated areas and distances. Zones may be set up by administrators for the tracking of asset tags, rights may be assigned to asset tags, events associated with assets and locations of assets may be defined, and alarms may be configured to facilitate an alert for the occurrence of an event associated with an asset tag.

An asset, within the scope of the invention, may be taken very generally. An asset may be a person. The person may be an employee of an organization, may be a student at a particular school or university, may be a soldier in the military, may be a student within a class, a member of a family, or may be any person whatsoever. An asset may also be a physical or tangible asset. A physical or tangible asset may be a laptop, may be an object of art, may be a computer memory device such as a CD-ROM, a solid-state thumb drive, or magnetic disc or tape. An asset may be a vehicle such as a rental car, a fire truck, a police vehicle, a military vehicle, or any other vehicle. An asset, in general, may be any object or person for which tracking the object may be of value to any person, organization, or entity.

In particular embodiments of the invention, an asset tag transmits data to a receiver/transmitter unit (RT unit). The RT unit determines the proximity of the asset tag and transmits data to a processing center which then determines from the data the location of the asset tag.

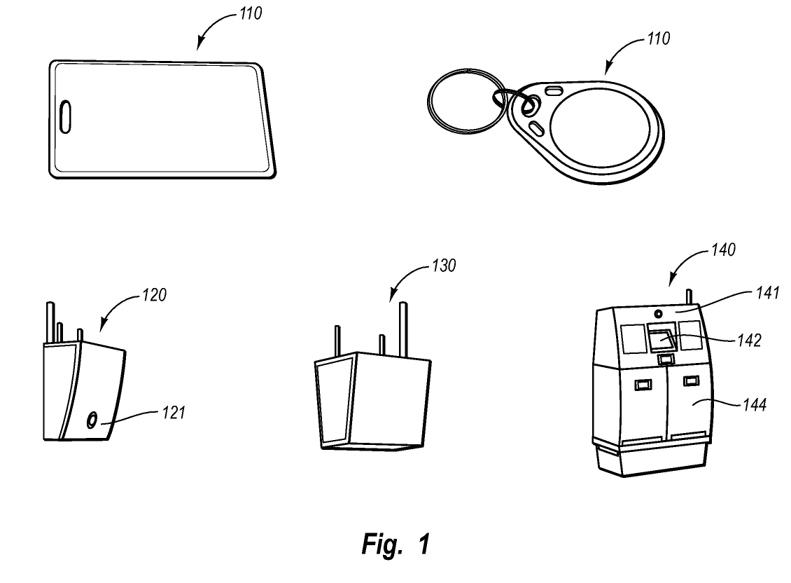

FIG. 1 illustrates devices and hardware which may be utilized in particular embodiments of the present invention. An asset tag 10 may be attached to an asset. Although a credit card sized tag 110 and a key fob type tag 110 are illustrated, it may be appreciated that an asset tag may take many different forms. Asset tags may be stand-alone units which may be attached to an asset, may be miniature forms which may be internally included within an asset, and may be in such a form as to be permanently affixed to an asset such as by tape, glue, or other physical attachment. Asset tags 110 may also be carried upon a person such as an employee picture identification badge, a key fob, or the like.

In a particular embodiment, an asset tag 110 is a radio frequency identification (RFID) device. The RFID tag 110 is enabled to transmit data associated with the asset tag and an asset identification. The data may be a unique number which is associated with a particular asset within a database or other persistent data store or the data may be identification data which is sufficient that, when received, is immediately associated with an asset. Such identification, may be a unique identification number such as a Social Security Number, an otherwise uniquely assigned number, or the name of a person or asset, itself For security, identification data transmitted by an asset tag can be encrypted or otherwise made secure using methods as are well known within such data transmission fields.

An RFID asset tag 110 may have a microchip attached to an antenna and may be packaged in a way to be attached to an asset. An asset, as discussed herein, should be taken as a general term to be any person, object, or other item for which tracking or instantaneous location determination may be considered useful.

RFID asset tags 110 may use many different frequencies, and may, for example (but not by limitation), include low-frequency, medium-frequency, high-frequency, and ultra-high-frequency or UHF radio communications. Microwave communication may also be used in some applications. Radio waves behave differently at different frequencies, so particular embodiments or particular applications may employ different frequencies as the particular embodiment or application may require or be desirable.

In certain embodiments, an asset tag 110 may transmit passively and in other embodiments it may transmit actively. An asset tag 110 may transmit only after receiving an interrogation signal from a source or may transmit only after receiving a prompt including secure identification information from a trusted source. In other embodiments, an asset tag may transmit at regular intervals or at such a time as it receives power from an external source as in a common proximity RFID reader. An asset tag may configured in such a way and have sufficient power to transmit over a long distance or may be configured to transmit over only a limited, pre-determined distance.

An asset tag 110 may transmit data associated with an asset identification. The asset identification may be within the data transmitted, itself, or may be associated within a persistent data store with asset tag data which is transmitted. The transmitted data may then be received by a receiver/transmitter unit (RT unit). An RT unit may be a unit 130 specifically designed and built to receive the transmitted data from the asset tag 110 on the proper frequency. An RT unit may also have sufficient processing capabilities and sufficient persistent memory to store data received from asset tags over a prolonged period of time. An RT unit 120 may be constructed such that, in addition to being capable of receiving the data transmitted by an asset tag it may also embody additional devices or functionality such as a camera (e.g., 121), gas detector, an air quality monitor, or other desired sensor. In certain embodiments an RT unit will include sufficient processing modules and capabilities and sufficient persistent data memory to store data which has been received over a period of time from asset tags. Additionally, RT units may store for a particular prolonged time data generated by the incorporated still or video cameras, gas detectors, air quality monitors, or other such devices as are included within the unit.

When devices such as cameras which may be directional are incorporated into an RT unit, the RT unit may also have the capability to receive instructions to direct or position the device in a particular manner. By such fashion, an RT unit may be directed to direct a camera at a particular portion of a building in which it is located.

In some particular embodiments, an RT unit may also be constructed to include an event response cabinet or facility 140 which would also include storage space 144 for emergency or event response supplies such as gas masks, an eye wash facility, supplemental oxygen, first aid supplies, and the like. In certain embodiments, an RT unit 140 may also include a display screen 142, computing systems, and input/output devices which may be used within particular embodiments of the present invention. The RT unit 140 may also include any devices as described herein as included in other RT devices (e.g., 120 and 130) such as an air quality monitor, smoke detector, or directable camera 141.

An asset tag 110 may be either active or passive. In one embodiment, an asset tag may transmit data using its own power at any time considered desirable. In another embodiment, an asset tag will transmit only when having been prompted by a signal from an interrogator. An asset tag may only transmit when having been powered by an external signal or other external power source (as is typical in some RFID proximity scenarios). An asset tag may be enabled to transmit data in an encrypted or otherwise secure fashion. Further, for purposes of security, an asset tag may be enabled to transmit data only after receiving and authenticating a particular prompt or interrogation signal. An asset tag may include computer processors, computer memory, and processing instructions to accommodate at least these and other functionality.

An RT unit (120, 130, or 140) is enabled to receive identification data transmitted from an asset tag 110. The RT unit may also be enabled to determine the proximity of an asset tag when receiving identification data from the tag. The determination of proximity by the RT unit of an asset tag utilizes methods well known in the field. Some proximity detection methods include (but are not limited to) signal strength detection and response time detection. RT units may also be enabled to transmit data to another receiver (which may or may not be another RT unit). The data transmitted by an RT unit may include the identification data received from an asset tag, may include proximity data for an asset tag, and may include identification of the particular RT unit transmitting, or position data for the RT unit, itself The position or location of the transmitting RT unit may be preconfigured and stored in a persistent data store or it may be determined, as in the case of a portable RT unit, by a GPS or other location sensor included within the unit. Further, in certain embodiments, the position or location of an RT device may also be determined from data associated with the transmitting RT unit which is stored in a persistent data store at the point of reception (either intermediate or ultimate) of the transmitted RT unit identification data.

If, in fact, an RT unit includes devices or facilities such as a camera, gas sensor, or air quality monitor—as they do in particular embodiments—the RT unit may also be enabled to transmit data produced by or associated with the included devices or facilities. For instance, an RT unit may transmit data comprising a picture or video taken by the included camera. An RT unit may transmit data associated with detected gas concentrations or with detected air quality information. A camera or other device included in an RT unit may also be directable or positionable and an RT unit which including such a camera may also be enabled to receive data which may be used to direct or position the camera or other device.

In particular embodiments, an RT unit (120, 130, or 140) would include a backup power supply which is independent of an external power source. Such a backup power supply would ensure that an RT unit would be capable of executing its functionality in the event that the power source of the building or location at which it is positioned fails. The included backup power supply, as desired within a particular application or embodiment, would be capable of providing adequate power to run the RT unit for any particularly pre-determined length of time.

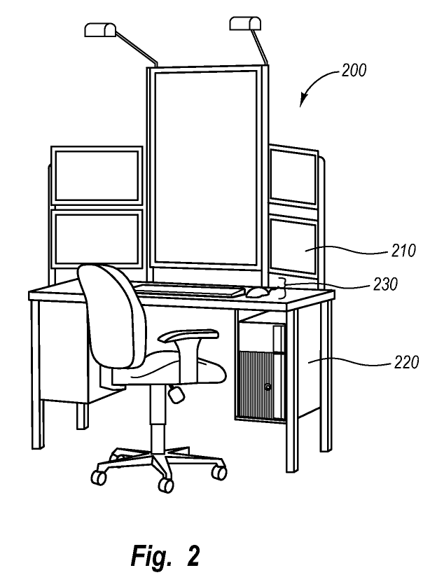

An RT unit, as well as receiving data from asset tags and being capable of transmitting data to other RT units, may also be capable of transmitting data to a processing center 200. FIG. 2 illustrates an example embodiment of such a processing center 200. For instance, a processing center may include multiple display screens 210, input devices such as a keyboard and mouse 230, and computer storage and processing devices and facilities 220. It should be noted that an RT unit and a processing center may, in fact, be incorporated into a single unit with the single unit comprising all the functionality of both the RT unit and the processing center. Further, a display screen 142 of an RT unit may also function as an input unit as well as an output unit by being a touch screen display or other such device.

Multiple RT units may be enabled to communicate among separated floors of a multistory building. In some commercial buildings, wireless communications may be problematic between floors. Accordingly, in certain embodiments of the present invention, floor-to-floor wireless communication is facilitated by communicating through available vertical shafts within the multi-story building. Such vertical shafts may be elevator shafts, HVAC shafts, utilities shafts, communication fiber or wire shafts, and the like. Generally, it may not be permissible to access such shafts from within the occupied space of the floors because of applicable building, safety, and fire codes and regulations. In particular embodiments of the invention, and RT unit gains access to such a vertical shaft for purposes of wireless communication by penetrating the vertical shaft in a manner in full compliance with all applicable building, fire, and safety codes and regulations. Such applicable codes and regulations may be given by (but are not limited to) the Uniform building Code (UBC), Underwriter's Laboratory (UL), the National Fire Protection Association (NFPA), federal, state, city and local codes, and other sources of codes and regulations.

One or more RT units may also be configured in particular embodiments to provide multiple channels of wireless communication. In this fashion, wireless communication may be provided for an asset tag tracking and management system or an emergency or event response system and, in addition, wireless communication may also be provided for an enterprise or entity deploying the RT units. RT units providing multiple channels or networks would be advantageous in that separate network infrastructures would not be necessary to provide an enterprise or entity with both an asset tracking or emergency or event response system and a normal data communication system. The multiple wireless communications channels may be provided in a separate and secure fashion so that communications on one network or channel are not dependent upon or interfere with the communications on another channel. Encryption and secure access may also be provided on any or all provided as channels and networks to enhance the security of the data communications.

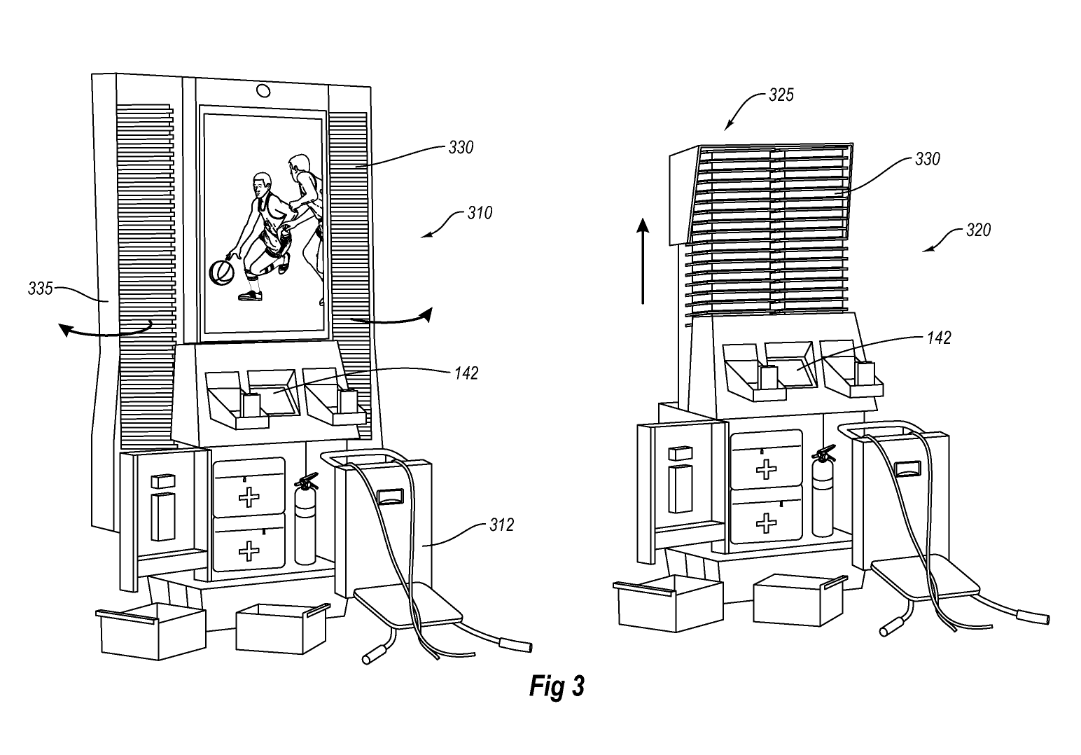

Other configurations for RT units within particular embodiments are depicted in FIG. 3. An RT unit 320 is shown which incorporates the functionality of the previously described RT units but also includes additional features and functions. The RT unit 320 also includes a shell having a base, a top, a plurality of substantially vertical walls between the base and the top, and a plurality of substantially horizontal walls connected to the vertical walls to form a plurality of open compartments. One or more doors may be attached to the shell, and the doors may be mechanically operable and arranged to close the compartments when closed and to provide access to the compartments when open. Doors or compartments included within the RT unit 320 may be mechanically operable in response to a detected alarm or event as described herein.

Compartment 325 is depicted after opening and may open in response to a detected emergency event to reveal housed breathing filters or gas masks 330. RT unit 320 (or a similarly equipped RT unit 140) may be equipped with such compartments which are mechanically operable to slide upward to open in response to an event. Such compartments may open by sliding, by rotating (e.g. 335), or other mechanical operation. Notably, RT unit 320 may be similar or identical to RT unit 140 described above. RT unit 320 is depicted in the open configuration while RT unit 140 is depicted in a closed configuration. Note that although emergency supplies may only be available after an event has caused the unit to open, the asset tracking and communications functionality of the unit may persist in any configuration.

The depicted RT unit 320 has a water supply system including at least one water supply tank removably stored in one of the compartments, and apparatus connected to the water supply tank to dispense water contained therein. The depicted unit 320 houses an eye-wash facility. The unit also has a waste water collection system including at least one waste water collection tank stored in one of the compartments, and tubing connected to the water collection tank to convey waste water to it. The shell may be made of plastic material or other suitable material with the vertical and horizontal walls integrally molded as a single apparatus. The unit comprises compartments which may have hinged doors and the compartments may have removable dividers, and doors may have window portions. The RT unit 320 may house first aid supplies and emergency supplies such as gas masks, iodine tablets, trauma response supplies, and the like. The amount of supplies and the number of gas masks housed by the RT unit 320 may vary depending on the size of the unit and the needs of the entity deploying the unit. An RT unit may be sized commensurate with the volume of supplies it is required to house.

Another RT unit 310 is depicted which may be preferably deployed in a public setting. In addition to the features described above, the unit 3 10 also comprises a display which may be either static or dynamic—such as a picture or an output of broadcast news or sports—which may serve to make the unit attractive or acceptable in a public setting. The outer shell of the unit may be configurable in any desired color or material. As with RT unit 320, RT unit 310 may also comprise doors and compartments. As depicted, doors 335 have mechanically opened in response to an event to reveal and make accessible a plurality of breathing filter devices or gas masks 330. However, in other modes of operation (e.g., in absence of some type of emergency) doors 335 remained in a closed configuration such that the contents of doors 335 are not available for use. Doors may be openable in response to a detected event or alarm or may be freely openable in various embodiments. Also, an RT unit may be configured in certain embodiments such that the opening of a door, either manually or automatically, generates an event, an alarm, or both.

Doors and panels of an RT unit may be removable and be useable for other purposes. The RT unit 310 is also depicted with an emergency carrying device 312. In one embodiment a plurality of handles are attached to a door and positioned such that the door can be used as a stretcher or a carrying chair to carry a sick or injured person. In another embodiment the door includes a movable portion that is deployed to increase its area, and a plurality of removable support legs are attached to the door when it is removed, thereby supporting the door in a generally horizontal position for use as a freestanding table.

Regardless of where an RT unit is positioned within a building, it may communicate throughout the building by access to vertical shafts within the building. By such access to the vertical shafts, the present invention may communicate wirelessly from floor to floor and from within the building to another point outside the building. For instance, five floors of a twenty story building may communicate with each other and may also communicate with an RT unit or repeater unit placed upon the roof of the building so as to communicate with an offsite facility. With an RT unit or repeater positioned on a roof of a building, it is possible for units within a building to communicate with a processing center which is housed in a location or building separated from the building housing the RT units. Such configurations facilitate third-party outsourcing of processing centers as well as disaster and emergency protection of possible processing center damage.

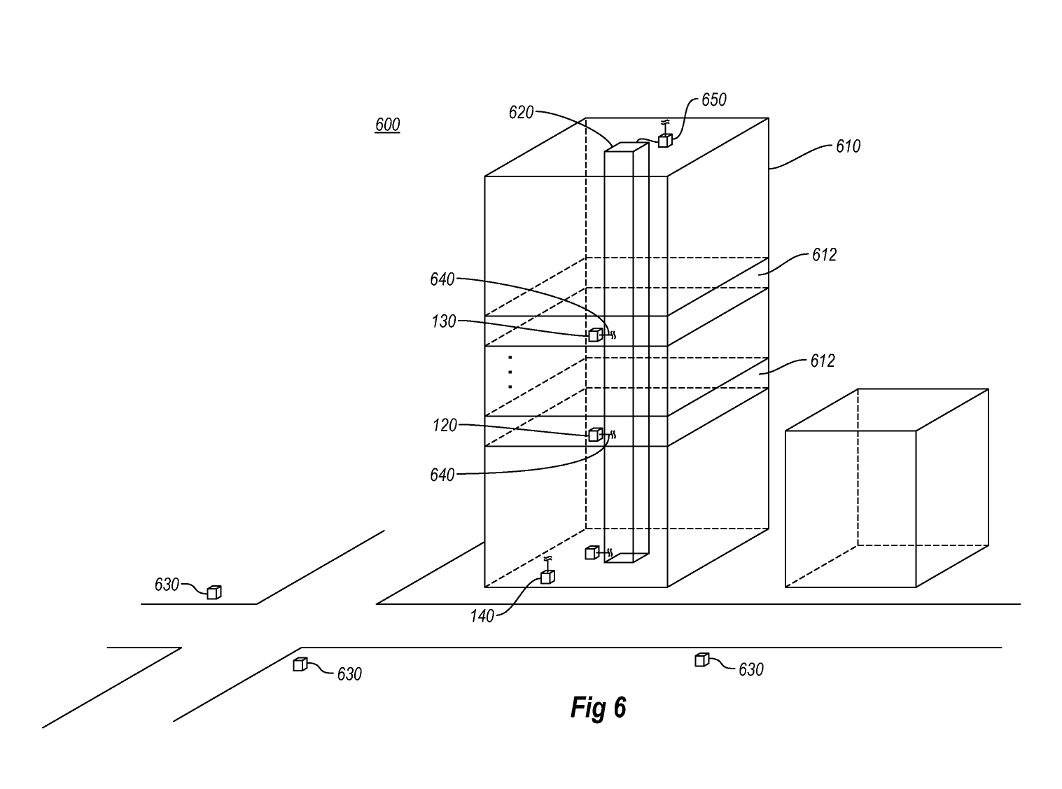

FIG. 6 depicts such a configuration within a multistory building. RT units 120 and 130 are situated on separate floors 612 of a multistory building 610. One of the RT units 120 on a particular floor is equipped with a camera which can capture and transmit both pictures and video of the floor and may be directable or positionable remotely. The RT units 120 and 130 have penetrated access 640 to the elevator shaft 620 of the building. Such penetrated access 640 to a vertical shaft adhering to and complying with all applicable building, fire, and safety codes and regulations. Having access to a vertical shaft within the building, each of the RT units may communicate with each other RT unit and may also communicate with an RT unit 650 situated on the roof of the building. The RT unit 650 on the roof of the building can communicate with an processing center which is located offsite at a location other than the building upon which the RT unit 650 resides. Furthermore, the rooftop RT unit 650 may be ruggedized or weatherized to withstand the elements and stresses which may be found in the open weather on a building roof Further, the rooftop RT unit may unit may use any of various communications technologies in order to facilitate short, medium or long range communications. The communication with the offsite processing center may be accomplished by WiFi, WiMAX, cellular, sattelite or other networking or communication technology as may be preferable or desirable within in a particular embodiment. The RT units may also communicate with an RT unit 140 situated on the ground floor of the building, possibly near the entrance. Such an RT unit 140 near the entrance may be placed in order to facilitate first responder access or to provide immediate information to evacuees (as discussed herein).

The RT units, as configured within the scope of the invention, both receive and transmit data. As such, as may be appreciated, the RT units may also be configured to provide for the normal wireless networking and data communications of an enterprise in which they are deployed. Such RT units may have multiple secure or encrypted channels so that normal wireless communications are separated and secure from the asset tag tracking and location functions. Such RT units may have physically separate wireless networking for each function. The particular wireless technology used, such as, for example, WiFi (IEEE 802.11), WiMAX (IEEE 802.16), 900 MHz radio, and cellular network, is not to be considered limiting but should be considered within the scope of the invention.

RT units may also be configured so allow store and facilitate the remote downloading of received data and stored data. Such downloading may be accomplished using any of the available and deployed communications technologies, including WiFi, WiMAX, cellular network, or even wired communications. In such a fashion, an RT unit which has been disconnected from another network by an event may still provide its data via a download functionality. Further, periodic downloads and/or backups of received data may preferably allow the historic tracking of assets and asset tags over a prolonged period of time.

A processing center 200 is enabled to receive data from one or more RT units and, when having received tag identification data, proximity data, and RT unit data, the processing center is enabled to determine the location of an asset tag and output the location data. The output of the location data may be in the form of a display upon a display screen 210, is may be data recorded in a database or other computer storage, may be in the form of printed or other hard-coded output, or may be in any other desired form.

A processing center may be located in close proximity to the RT units with which it is associated, such as within the same floor or within the same building. In a typical instance, a processing center may be located within a so-called command center within a large, multi-story, office building. In other embodiments, a processing center may be located remotely from a building or area housing the associated RT units.

The processing center may use tag identification data to look up the asset associated with the asset tag in a database or other computer data store. The processing center may also determine the asset associated with the asset tag from data contained with the asset tag data, itself The processing center may determine the location of the asset tag (and the associated asset) by means of triangulation using asset tag data and proximity data from a multiple of RT units or it may determine a location based upon the data from a single RT unit.

In certain embodiments, an asset tag 10 may transmit position data along with its identification data. Such data may be provided by, for instance, a GPS receiver/sensor included within the asset tag. In other embodiments, an RT unit may have an included GPS receiver and the RT unit may transmit asset tag data along with its own position data as determined by the GPS receiver. In other embodiments, an RT unit, which may be permanently or semi-permanently installed at a particular location, may transmit its position from position data stored within computer-readable media and configured within the RT unit, itself.

By such configuration, an RT unit may transmit data which indicates that it is positioned on a particular floor of a particular building in a particular city of a particular country. In other embodiments, an RT unit may transmit its own identification data which the processing center may then look up in a database or other store or otherwise process to determine that the RT unit is in a particular location. In general, a processing center may determine position data from data received, may calculate position data, or may look up position data in a database or other persistent data store.

Position data may be in different forms in particular embodiments. Position data may be given by latitude, longitude, and altitude. Position data may also be given in coordinates of a local coordinate system as may be used in a particular location or by a particular governmental entity or in coordinates given by any other public or private entity. Position data may be given by a room number at a particular address within a particular city. In general, position data may be given, calculated, or determined in whatever form is desirable within a particular application.

A processing center may accommodate processing data and determining locations by the use of a data structure encoded within a persistent computer-readable medium. FIG. 5 depicts an example of such a data structure 500. Such a data structure may include an asset field 515 containing a description of an asset corresponding to the identifier contained within the tag field. An asset may be any person, object, vehicle, or the like. The data structure may also include a tag field 510 containing an identifier that is transmitted from an asset tag which is used within an asset tracking system, the asset tag being associated with the asset. The data structure may also include a country field 520 containing data associated with a country, the country being associated with the country of the location of the described asset. The data structure may also include a city field 530 containing data associated with a city, the city being associated with the city of the location of the described asset. The data structure may also include a building field 540 containing data associated with a building, the building being associated with the building of the location of the described asset. The data structure may also include a floor field 550 containing data associated with at least one of a floor or a room within a building, the floor or room being associated with the floor or room of the location of the described asset. Although an example 500 of such a data structure is described, an actual data structure in a particular embodiment may have additional fields or may have fewer fields as are desirable within the particular embodiment.

The data structure, as can be appreciated, in certain embodiments, may also be extensible in order to accommodate other data and fields as would be advantageous in particular embodiments of the invention. For instance, the data structure may be extended in particular embodiments to comprise data associated with an event, an alarm, or a zone which may be associated with an asset. Further, to accommodate historic tracking of assets and asset locations, the data structure may be extended to include a timestamp or other data associated with a particular time and may be extended to included a location at a particular time.

A processing center may determine or calculate a position or location for an asset tag and its associated asset in a number of ways. The processing center may have information indicating the identification and known position of each of the RT units from which is receives data. Using this information and the information of the asset tag and proximity information, the processing center may calculate the position of an asset tag. In other embodiments, an RT unit may transmit its location along with other data to the processing center. Such an embodiment may be preferable and particularly useful in a situation where portable RT units are desired to respond to an event or to be temporarily deployed. Such calculations using RT unit position data and asset tag proximity data may be accomplished by using triangulation and other well known techniques.

Once position data is determined at or by a processing center, the processing center may also be enabled to output or display the position of an asset tag (and its associated asset) within a three-dimensional model of the location. For instance, an asset may be located within a particular room on a particular floor of a particular building. A processing center may display a three dimensional model building of the building within an indication of the asset at the determined location within the three-dimensional model. The processing center may also be enabled to zoom in on the model showing greater detail or zoom out on the model showing lesser detail. In certain embodiments, a processing center may be placed at strategic locations within a building which may then exhibit on a display the locations of all people within a building so as to facilitate emergency response or evacuation.

There are no limits on the ability to zoom in or out within a three-dimensional model. Limited only by the data and detail stored within the three-dimensional model, a processing center may zoom in to a great detail, for instance, showing the location of an asset tag amongst the furniture of a particular room in a particular building. A processing center may also zoom out to depict the determined location of an asset tag as only within a particular city within a particular country. As may be appreciated, the ability to zoom in or out depends on the detail supplied with the model but is not limited by the processing center.

By using data received from so-equipped RT units, a processing center may display the location of people within a three-dimensional model as well as locations of air determined to the unhealthful by the incorporated air quality sensors. In such a fashion, it may be determined and displayed or output proper or available routes through a building during an emergency event.

The two or three-dimensional models may be created, ad hoc, for a particular application or may be imported from various CAD formats. Additionally, the invention is not limited to three-dimensional models. A two-dimensional model, as an included subset of a three-dimensional model, should also be considered to be included within the scope of the invention.

As well as locating an asset tag by any coordinate system or within a two or three-dimensional model, an asset tag may be located within a particular zone. Within the invention, a zone is any area which can be defined by an operator at any time. A zone may be a particular floor of a particular building. A zone may be a particular group of rooms within one or more buildings. A zone may be given by a particular perimeter given in terms of latitude, longitude and altitude. A zone need not be contiguous such that rooms separated by floors may be within a single particular zone.

A zone may be fixed in time or may be changeable over time. For instance, a zone may be a particular floor of a building at one time but move to another floor of a building at another time. Such movement of a zone may be useful in certain situations such as tracking cleaning equipment as a cleaning crew moves throughout a building during the ordinary course of business. Such a movable zone may also be useful for emergency responders who are searching or servicing different areas of a disaster event over a span of time.

Zones may also be associated with a particular asset or asset tag. For instance, if a group of assets, in this case people, included a teacher and a group of students, a zone may be associated with a certain perimeter or radius surrounding the teacher. In this fashion, a processing center may determine if all students were within the zone associated with the teacher. As might be appreciated, this may be useful for teachers and students, parents and children, emergency responders in an emergency event, or other such situation.

For instance, a zone may be configured by emergency response personnel in response to an emergency event. In FIG. 6, RT units 630 are depicted in an area outside a multistory building 610. Such RT units 630 may be equivalent in form an function as RT units described herein (e.g. 120, 130, 140) or may incorporate additional features and aspects. Such RT units may be portable, field deployable, ruggedized, and may have been temporarily deployed by event response personnel in response to an emergency or other event associated with the building. In this example, it may be advantageous to, as in certain embodiments, have the temporarily deployed RT units 630 equipped with GPS location receivers so that emergency response personnel may simply deploy the RT units quickly wherever desired and the RT units 630 could quickly and efficiently determine and transmit their position to a processing center without the necessity of further manual configuration. Of course, if position information is not dynamically available to the RT unit from, for instance, a GPS unit, the units may still be quickly configured as to their position.

With the portable and field deployable RT units 630 deployed, a zone may be configured to include the area immediately outside the entrances to and exits from the building. In this situation, a processing center may be configured to determine if all people (who had associated asset tags) had successfully evacuated from the building by determining which asset tags entered the zone. Further, the processing center may be able to determine which emergency responders have entered the building, which are on which particular floors, and which have successfully retreated from the building as may be necessitated by some occurrence.

In the above example, the RT unit 140 on the ground floor of the building may also include a processing center and a display 142. In this particular embodiment, the emergency response personnel may have immediate access to information determined by the processing center as to the positions of people within the building, to transmitted pictures or video from cameras included within RT units, to data associated with air quality monitoring, or data acquired by other devices as included within the RT units within the building. In such a fashion, an emergency responder may determine that a person on a particular floor had not moved in too long a time, that the floor was filled with smoke, and a properly-equipped responder must be dispatched to rescue the trapped or otherwise immobile person. An emergency responder may also direct a camera within an RT unit to view the smoke or fire or other situation on a floor which may otherwise be unknowable without the physical presence of a responder. In such fashion, emergency response to events may be greatly facilitated and made considerably safer.

In another embodiment of the invention, an RT unit may be configured to communicate with an event response unit. An event response unit may be an RT unit or a processing center which may be deployable for an event. Such an event, for instance, may be an emergency or a disaster and the event response unit may be a portable unit which is housed within a fire truck or other emergency vehicle. In such a fashion, an event response unit may have access to the data associated with asset tags and RT units which are affected by a particular event. Such an event response unit may have any and all of the functionality, as may be desired, as does an RT unit or processing center. Further, an event response unit may be enabled to have a secure access to other RT units and processing centers.

A processing center may be further enabled to associate certain rights with particular assets. For instance, a particular asset may have a right to enter a particular room or zone. Such a right would permit a processing center to determine if an asset (or person) has to right to enter a particularly sensitive room, zone, or area within a particular building. In another instance, a particular asset may have no right to leave a particular room or building. In such an instance, an asset such as a laptop or computer storage device may have no right to leave a secure area of a building or the building, itself.

A processing center may also be enabled to issue alarms associated with particular events associated with asset tags and assets. For instance, an alarm may be issued if a particular asset leaves a zone it has no right to leave. In this manner, if a laptop or computer storage device were to be taken from a room for which it was configured as having no right to leave, the processing center would detect the violation of the right and issue an alert associated with the event associated with the violation of the right. Such alarms and event may be configured in both a positive and negative fashion. That is, an alarm may be configured for an alert upon an event such as a person entering a room or zone for which the person has no associated right to enter. In a contrasting situation, an alarm may also be configured for an alert upon an event such as a object of art or other valuable tangible object leaving a room for which it has no associated right to depart.

Assets may be associated as groups. Such a group, for instance, may be a teacher and a number of students. An event associated with an alarm may be the event that the location of a student member of the group becomes farther than a specified limit away from the location of the teacher member of the group. Such associations of groups and events may be useful for teachers and students, members of emergency response teams, tour groups, and the like. Other groups which may be associated are assets which share particular rights such as access rights to particular locations or which share particular negative rights such as no right to leave a particular building (as may be useful for valuable and protected tangible assets).

Alarms as discussed herein may be configured to be output in any of a variety of fashions and should not be considered limiting. An alarm may be a sound, a display, a signal transmitted to another receiver or device, an item logged to a persistent storage facility, or a printed output. The actual form of the alarm should be considered general, not limited, in fully encompassed within the scope of the present invention.

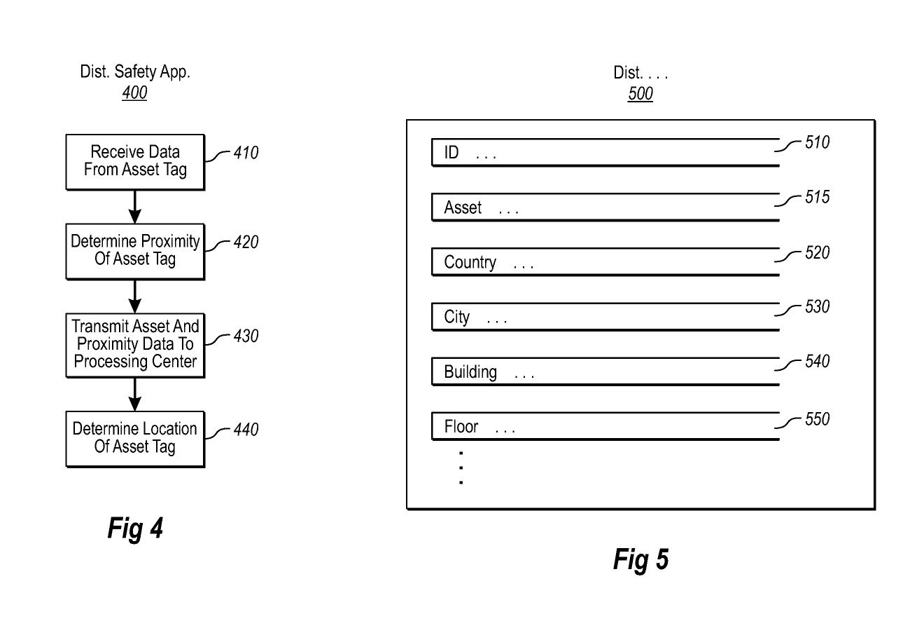

As can be appreciated from the discussion herein, the present invention may also be described by a method as depicted in FIG. 4. The method 400 includes and act 410 of receiving data from an asset tag. The data received from the asset tag may be identification data for the tag or identification data associated with an asset which is associated with the tag. The method includes an act 420 of determining the proximity to the receiver of the asset tag when the data is received from the asset tag. Such proximity data may then be used, in conjunction with the identity or location of the receiver to determine the location of the asset tag and the associated asset.

The method also includes an act 430 of transmitting data which includes the identification data for the asset tag or the asset and the proximity data to a processing center. The method includes an act 440 of determining the location of an asset tag based at least in part upon the data transmitted to the processing center. In a typical embodiment, a processing center will use data from one or more RT units which includes identification data from an asset tag, proximity data for the asset tag to the RT unit, and the identity or location of the transmitting RT unit to determine the location of an asset tag and its associated asset. In some embodiments, data from multiple RT units may be used by a processing center to triangulate the multiple RT units or otherwise calculate a more accurate location of an asset tag for which data is received by multiple RT units.

The method 400 also incorporates acts and devices having assess to a vertical shaft of a multi-story building. The access is accommodated via penetration or other suitable access to a vertical shaft which adheres and complies with all applicable building, fire, and safety codes and regulations. By such access, data may be transmitted through or within a vertical shaft and service may be provided to, and tracking may be accomplished for multiple floors of a multi-story building.

As described herein, a processing center may also determine the location of an asset tag or its associated asset and associate that location within a model of the area surrounding the location. The model may be a two-dimensional model or, preferably, a three-dimensional model of the surroundings of the location of the asset. Such a three dimensional model may be a CAD depiction, as is typical in architecture, of a multi-story building depicting floors within the building and rooms within a floor of a building. In such a fashion, the location of an asset may be depicted within a three-dimensional model showing any instantaneous or historic location of an asset. The processing center may output the depiction of the location in any desirable manner including a display upon a screen, a printed output, or as data recorded to a persistent data store for later retrieval.

The method for tracking asset tags and assets may also receive data and determine and track locations in real-time. By such functionality, a user of the system may view an output of the real-time movement of an asset and, as described above, view the real-time movement of a tracked asset within a model of the area or surroundings of the location of the asset. While real-time asset tracking is made possible, it is also within the scope of the invention to record and maintain the historic location data for any tracked asset in a persistent data store for later retrieval. In such a fashion, the past movement of any tracked asset may be viewed at any desirable later time or the location of a tracked asset at any particular past time may be determined.

By using particular embodiments of the system and methods described herein, it may be useful to track, store, and download location information for particular groups of assets during a particular time or after a particular event. For instance, a group of people may be tracked during a fire drill and the performance of the fire drill may be later examined for effectiveness by examining the locations over time of the people affected by the fire drill. The response of emergency response personnel may similarly be tracked and examined. A group of policemen or firemen responding to a mock disaster drill may be tracked and their response analyzed by examining the locations of the responders over the time of the response test.

Although particular embodiments are described herein, the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising a distributed safety apparatus for determining and tracking the location of asset tags, the system comprising:
one or more asset tags enabled to transmit data associated with an asset identification;
one or more receiver/transmitter (RT) units enabled to receive identification data from an asset tag, enabled to determine the proximity of a tag when receiving identification data from an asset tag, enabled to transmit to another receiver data comprising identification data and proximity data for each tag for which the RT unit has received identification data, each RT unit having a backup power supply independent of external power sources; and
a processing center enabled to receive data from one or more RT units, the processing center when having received tag identification data, proximity data, and RT unit data, being enabled to determine the location of an asset tag and output location data.

2. The system of claim 1 wherein the processing center is further enabled to display location information for an asset tag within a three-dimensional model.

3. The system of claim 1 wherein the processing center is further enabled to associate location information for an asset tag with a predefined zone.

4. The system of claim 1 wherein the processing center is further enabled to associate asset tag information with predetermined rights.

5. The system of claim 1 wherein at least one RT unit is further enabled to receive identification data and proximity data from one or more other RT units.

6. The system of claim 1 wherein at least one RT unit is configured to communicate through a vertical shaft of a multistory building, the access to the vertical shaft conforming with all applicable building, fire, and safety codes and regulations.

7. The system of claim 6 wherein a plurality of RT units are located on a plurality of floors of a multistory building and are coupled through wireless communication.

8. The system of claim 1 wherein the processing center is located is a building separated from a building housing at least one RT unit.

9. The system of claim 1 wherein at least one RT unit comprises a camera and is further enabled to transmit picture data from the camera to the processing center.

10. The system of claim 1 wherein the RT unit comprises an air quality monitor and is further enabled to transmit air quality data to the processing center.

11. The system of claim 1 wherein the one or more RT units are further enabled to provide wireless networking.

12. The system of claim 1 wherein at least one RT unit is portable and comprises a GPS location receiver and is enabled to transmit the GPS location to the processing center.

13. The system of claim 1 wherein at least one RT unit is enabled to communicate via a cellular network and is further enabled to download stored data via the cellular network.

14. The system of claim 1 wherein at least one RT unit comprises a computer display which is enabled to display location information for assets associated with asset tags.

15. The system of claim 1 wherein the processing center is enabled to issue an alarm upon detecting an event associated with the determined location of one or more asset tags.

16. The system of claim 1 wherein the location of an asset tag comprises country, city, building, and floor.

17. The system of claim 1 wherein at least one RT unit or processing center is portable and field deployable.

18. The system of claim 1 wherein at least one RT unit or processing center is incorporated within an emergency response unit including eye wash facilities and a gas mask.

19. A method for tracking asset tags, the method comprising:
receiving by an RT unit data transmitted from an asset tag, the data associated with the identification of an asset;
determining the proximity of the asset tag having sent the data to the receiving RT unit;
transmitting the asset tag data, proximity, and RT unit identification to a processing center; and
the processing center determining the location of the asset tag based at least in part upon the received data.

20. The method of claim 19 wherein transmitting the asset tag data, proximity, and RT unit identification to a processing center comprises transmitting data through a vertical shaft of a multistory building, the access to the vertical shaft for transmission being accomplished in accordance with all applicable building, fire, and safety codes and regulations.

21. The method of claim 19 further comprising the processing center displaying the location of an asset tag within a three dimensional model.

22. The method of claim 19 further comprising the processing center tracking the location of an asset tag in real-time and maintaining in a data store historic asset tag location data.

23. A data structure encoded upon a computer-readable, the data structure to be used within a system for tracking assets through the detection of asset tags, the data structure comprising:
a tag field containing an identifier that is transmitted from an asset tag which is used within an asset tracking system;
an asset field containing a description of an asset corresponding to the identifier contained within the tag field;
a country field containing data associated with a country, the country being associated with the country of the location of the described asset;
a city field containing data associated with a city, the city being associated with the city of the location of the described asset;
a building field containing data associated with a building, the building being associated with the building of the location of the described asset; and
a floor field containing data associated with at least one of a floor or a room within a building, the floor or room being associated with the floor or room of the location of the described asset.

24. A system for determining and tracking the location of asset tags and for providing wireless network communications for an enterprise, the system comprising:
one or more receiver/transmitter (RT) units enabled to communicate over a plurality of secure wireless communication channels, at least one wireless communication channel being used for receiving and transmitting data associated with an asset tracking network, and at least one wireless communication channel being used for a data communications within an enterprise network;
the RT units enabled to receive, transmit, and forward wireless communications on each of the asset tracking network and the enterprise network to multiple floors of a multistory building by communicating through access to a vertical shaft of a building, the access to the vertical shaft adhering to all applicable building, fire, and safety codes and regulations;
the RT units further enabled to receive identification data from an asset tag, enabled to determine the proximity of a tag when receiving identification data from an asset tag, enabled to transmit to another receiver data comprising identification data and proximity data for each tag for which the RT unit has received identification data, each RT unit having a backup power supply independent of external power sources; and
a processing center enabled to receive data from one or more RT units, the processing center when having received tag identification data, proximity data, and RT unit data, being enabled to determine the location of an asset tag and output location data.

25. A system comprising a distributed safety apparatus for determining and tracking the location of asset tags and comprising emergency response supplies, the system comprising:
one or more receiver/transmitter (RT) units enabled to receive identification data transmitted from an asset tag, the RT unit enabled to determine the proximity of a tag when receiving identification data from an asset tag, enabled to transmit to another receiver data comprising identification data and proximity data for each tag for which the RT unit has received identification data, each RT unit having a backup power supply independent of external power sources;
a computer display device configured to display location information for assets associated with asset tags;
a physical cabinet comprising one or more attached mechanically operable doors arranged to close a plurality of compartments when closed and to provide access to the compartments when open, at least one door being removable and comprising handles such that the door, when removed, may be used as a carrying device; and
a plurality of emergency supplies housed within the compartments, the supplies comprising a gas mask, an eye wash and a water dispenser.
